(19) United States
(12) Patent Application Publication
(10) Pub. No.: US 2025/0177892 A1
(43) Pub. Date: Jun. 5, 2025

(54) FILTER

(71) Applicant: Suzhou Luxshare Technology Co., Ltd., Suzhou City (CN)

(72) Inventors: Wei WANG, Suzhou City (CN); Dongsheng XUE, Suzhou City (CN); Wenbo GUO, Suzhou City (CN)

(73) Assignee: Suzhou Luxshare Technology Co., Ltd., Suzhou City (CN)

(21) Appl. No.: 18/931,285

(22) Filed: Oct. 30, 2024

(30) Foreign Application Priority Data
Dec. 1, 2023 (CN) 202323279887.6

(51) Int. Cl. B01D 35/30; B01D 46/00

(52) U.S. Cl. CPC B01D 35/30; B01D 46/0002; B01D 2201/30; B01D 2201/4092; B01D 2265/029

(57) ABSTRACT

Provided is a filter including a housing, a cover plate, a support seat, a connector, a metal rod, a tap, a mounting block, and a locking bolt. The cover plate is provided with a mounting hole and a threaded hole. The support seat penetrates through the mounting hole. The connector is disposed in the support seat. One end of the metal rod is connected to another end of the connector. The tap is disposed in the housing and connected to another end of the metal rod. The mounting block is provided with a receiving recess on one side of the mounting block and a reference surface on another side of the mounting block. The reference surface has a stop hole and a connection hole that are connected to the bottom of the receiving recess. The reference surface abuts against the side of the cover plate facing away from the housing.

### CROSS-REFERENCE TO RELATED APPLICATION(S)

This application claims priority to Chinese Patent Application No. 202323279887.6 filed Dec. 1, 2023, the disclosure of which is incorporated herein by reference in its entirety.

### TECHNICAL FIELD

The present application relates to the field of filter technologies, particularly a filter.

### BACKGROUND

In a filter, a cover plate and a housing form a cavity, a support seat penetrates through the cover plate, a connector and a metal rod are coaxially connected to each other, the connector is disposed in the support seat, one end of the connector extends out of the support seat, the metal rod is located in the housing of the filter and connected to a tap. A mounting block is an important component in the filter. The mounting block is secured outside the cover plate and configured to limit the position of the support seat that protrudes from the cover plate. An existing mounting block is formed in a die casting process. A part of the mounting block connected to a locking screw of the cover plate is suspended. As a result, the screw cannot be easily locked, and deformation is prone to occur when the locking force is too large.

### SUMMARY

The present application is aimed to provide a filter in which the connection between a mounting block and a cover plate is more stable and reliable.

The present application adopts the solutions below.

The filter includes a housing, a cover plate, a support seat, a connector, a metal rod, a tap, a mounting block, and a locking bolt. The cover plate is disposed at an opening of the housing. The cover plate is provided with a mounting hole and a threaded hole. The support seat penetrates through the mounting hole. The connector is disposed in the support seat. One end of the connector extends out of the end of the support seat facing away from the housing. One end of the metal rod is connected to another end of the connector. The tap is disposed in the housing and connected to another end of the metal rod. The mounting block is provided with a receiving recess on one side of the mounting block and a reference surface on another side of the mounting block. The reference surface has a stop hole and a connection hole that are connected to the bottom of the receiving recess. The reference surface abuts against the side of the cover plate facing away from the housing. The support seat penetrates through the stop hole. The locking bolt penetrates through the connection hole and is threadedly connected to the threaded hole.

Two stop holes are provided, the connection hole is formed on the symmetric surface of the two stop holes, and each of the two stop holes is configured with one support seat.

Two connection holes are provided, and the two stop holes are formed on the symmetric surface of the two connection holes.

A connection groove is disposed on the reference surface, and the connection groove connects the two stop holes.

The housing is provided with a support seat receiving recess, a tap receiving recess is disposed at the bottom of the support seat receiving recess, an annular boss is disposed on the periphery of the support seat, the annular boss is sandwiched between the bottom of the support seat receiving recess and the cover plate, and the tap is disposed in the tap receiving recess.

The filter also includes a sealing ring sleeved on the support seat and sandwiched between the annular boss and the cover plate.

The support seat is provided with a through hole along the axis of the support seat, a threaded portion is disposed at the end of the through hole facing away from the housing, the connector is threadedly connected to the threaded portion, a part of the metal rod is located in the through hole, and the tap is located outside the through hole.

The connector includes a head and a threaded connection portion that are coaxially connected to each other, the diameter of the head is greater than the diameter of the threaded connection portion, the head abuts against the side of the support seat facing away from and the housing, and the threaded connection portion is threadedly connected to the threaded portion.

The connector also includes a rod penetrating through the head and the threaded connection portion, and the end of the rod extending out of the threaded connection portion is clamped in the metal rod.

The mounting block is formed by stamping a sheet.

The present application has the beneficial effects below.

The reference surface of the mounting block enables the mounting block to abut against the cover plate so that stability and reliability are ensured when the locking bolt is locked and deformation is not prone to occur when the locking force is too large. On this basis, the receiving recess better limits the position of the support seat that protrudes from the cover plate.

### BRIEF DESCRIPTION OF DRAWINGS

FIG. 1 is a view illustrating the structure of a filter according to an embodiment of the present application.

FIG. 2 is a section view illustrating part of the filter according to an embodiment of the present application.

FIG. 3 is a view illustrating the structure of some components of the filter according to an embodiment of the present application.

FIG. 4 is a view taken from one orientation to illustrate that a support seat, a connector, a metal rod, a tap, a mounting block, a locking bolt, and a sealing ring cooperate with each other according to an embodiment of the present application.

FIG. 5 is a view taken from another orientation to illustrate that the support seat, the connector, the metal rod, the tap, the mounting block, the locking bolt, and the sealing ring cooperate with each other according to an embodiment of the present application.

FIG. 6 is a view taken from one orientation to illustrate the structure of the mounting block according to an embodiment of the present application.

FIG. 7 is a view taken from another orientation to illustrate the structure of the mounting block according to an embodiment of the present application.

FIG. 8 is a view illustrating that the support seat, the connector, the metal rod, the tap, and a sealing ring cooperate with each other according to an embodiment of the present application.

FIG. 9 is a section view of the structure shown in FIG. 8.

### REFERENCE LIST

1. housing, 11. support seat receiving recess, 12. tap receiving recess
2. cover plate
3. support seat, 31. annular boss, 32. through hole
4. connector, 41. head, 42. threaded connection portion, 43. rod
5. metal rod
6. tap
7. mounting block, 71. receiving recess, 72. reference surface, 73. stop hole, 74. connection hole, 75. connection groove
8. locking bolt
9. sealing ring

### DETAILED DESCRIPTION

Embodiments of the present application are described in detail hereinafter. Examples of the embodiments are illustrated in the drawings, where the same or similar reference numerals indicate the same or similar elements or elements having the same or similar functions. The embodiments described below with reference to the drawings are exemplary, intended to explain the present application and not to be construed as limiting the present application.

In the description of the present application, unless otherwise expressly specified and limited, the term “interconnected”, “connected” or “fixed” is to be construed in a broad sense, for example, as securely connected or detachably connected; mechanically connected or electrically connected; directly interconnected or indirectly connected to each other via an intermediary; or internally connected between two components or interactional relations between two components. For those of ordinary skill in the art, specific meanings of the preceding terms in the present application may be understood according to specific situations.

In the description of the present application, unless otherwise expressly specified and limited, when a first feature is described as “on” or “below” a second feature, the first feature and the second feature may be in direct contact, or the first feature and the second feature may be in contact via another feature therebetween instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

Solutions of the present application are further described below through embodiments in conjunction with the drawings.

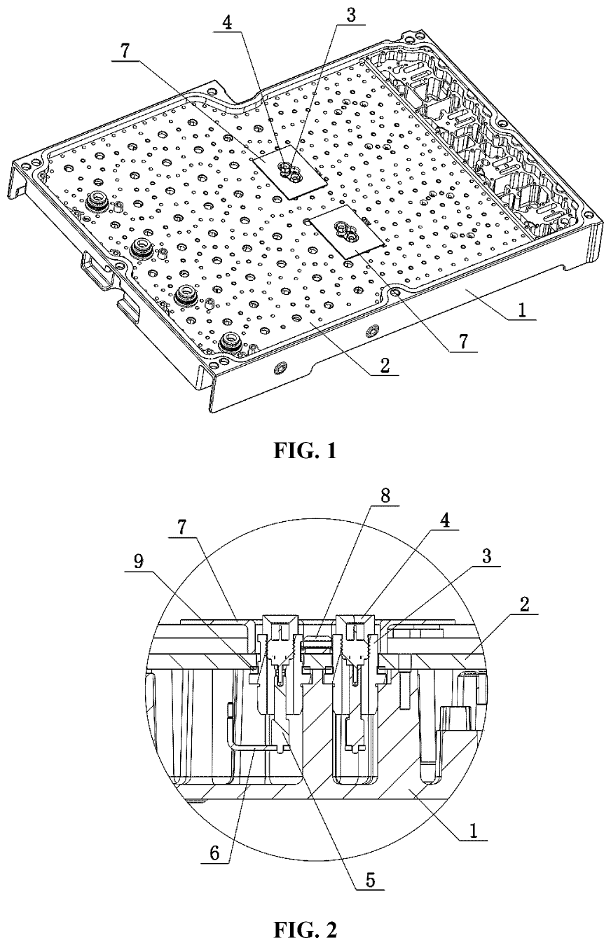

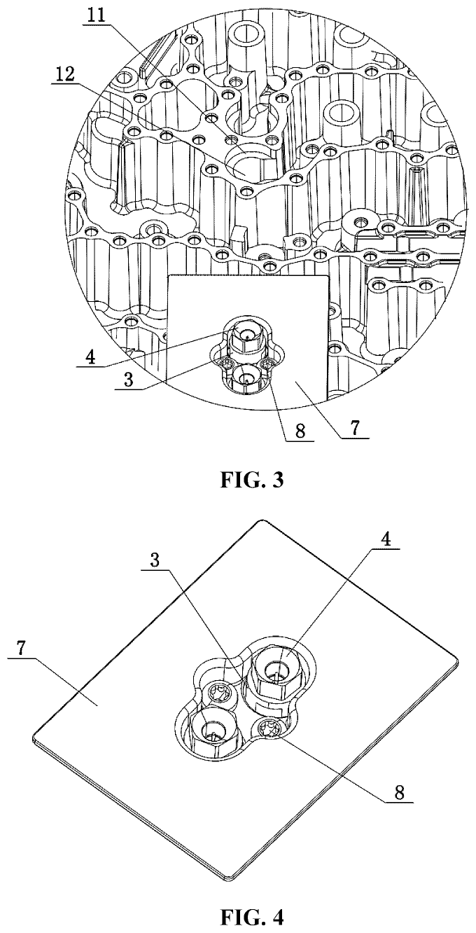

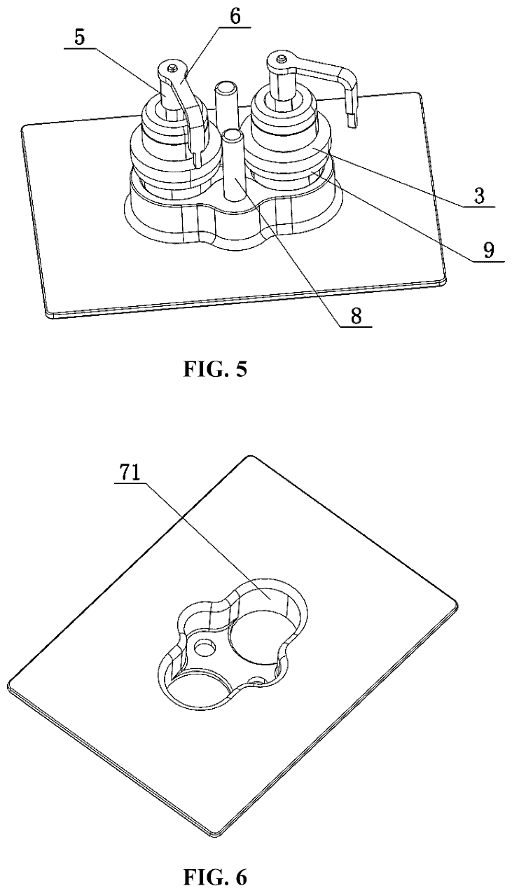

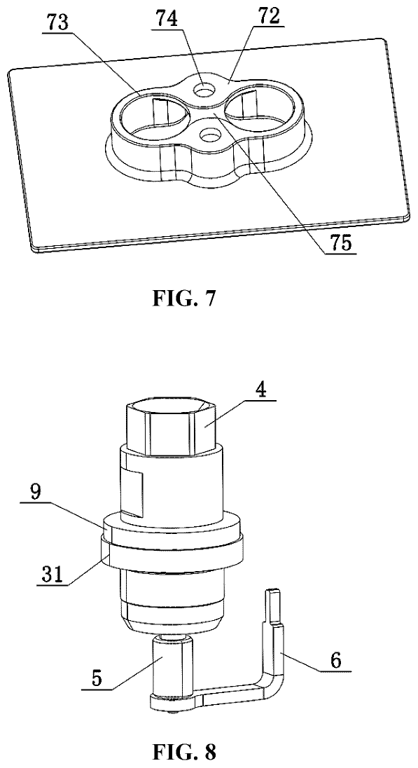

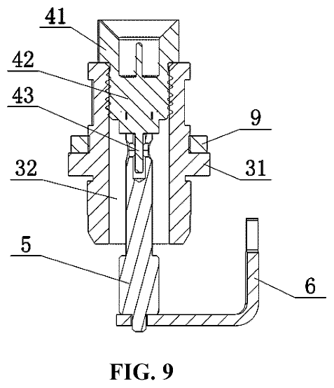

As shown in FIGS. 1 to 9, the present application provides a filter. The filter includes a housing 1, a cover plate 2, a support seat 3, a connector 4, a metal rod 5, a tap 6, a mounting block 7, and a locking bolt 8. The cover plate 2 is disposed at an opening of the housing 1. The cover plate 2 is provided with a mounting hole and a threaded hole. The support seat 3 penetrates through the mounting hole. The connector 4 is disposed in the support seat 3. One end of the connector 4 extends out of the end of the support seat 3 facing away from the housing 1. One end of the metal rod 5 is connected to another end of the connector 4. The tap 6 is disposed in the housing 1 and connected to another end of the metal rod 5. The mounting block 7 is provided with a receiving recess 71 on one side of the mounting block 7 and a reference surface 72 on another side of the mounting block 7. The reference surface 72 has a stop hole 73 and a connection hole 74 that are connected to the bottom of the receiving recess 71. The reference surface 72 abuts against the side of the cover plate 2 facing away from the housing 1. The support seat 3 penetrates through the stop hole 73. The locking bolt 8 penetrates through the connection hole 74 and is threadedly connected to the threaded hole.

In the present application, the reference surface 72 of the mounting block 7 enables the mounting block 7 to abut against the cover plate 2 so that stability and reliability are ensured when the locking bolt 8 is locked and deformation is not prone to occur when the locking force is too large. On this basis, the receiving recess 71 better limits the position of the support seat 3 that protrudes from the cover plate 2.

An existing mounting block 7 separately prepared by die casting requires secondary processing of a die-cast workblank, requires removal of structures including gates and slag around the periphery of the workblank, requires processing of key surfaces such as the opening surface of the receiving recess 71 and the reference surface 72 on a numerically-controlled machine tool, and requires removal of burrs from the processed components, involving long processing time, high costs, high mold preparation costs, and poor product indicators.

In this embodiment, the mounting block 7 is formed by stamping a sheet. Compared with the die-cast mounting block 7, the stamped mounting block 7 of this embodiment has the following advantages:

1. The receiving recess 71 and the reference surface 72 are formed by being stretched, so the receiving recess 71 and the reference surface 72 have a more stable size and a better flatness and require no secondary processing.

2. The stretching process is simpler than the die casting process and can be completed by a stamping mold in one step. The processing period is shorter. The preparation costs of the mold are lower. (Die casting usually uses AlSi12, 44300, ADC12, and 43400 materials. Stretching uses 4-series, 5-series, and 6-series aluminum materials. Compared with die casting materials, stretching materials involve lower costs, stable size, and no defect such as die casting pores, voids, cracks, or poor compactness.)

3. The weight is lighter. (The wall thickness of the component is 5-8 mm or larger in traditional die casting. The wall thickness of the component is 3 mm or smaller. The component is formed by being stretched. The weight is 40% to 60% lighter than the die-cast component.)

4. The performance of the product is better. (The expansion coefficient of 4-series, 5-series, and 6-series aluminum materials is about 23.6. The expansion coefficient of AlSi12, 44300, ADC12, and 43400 materials is about 21.5. The performance of 4-series, 5-series, and 6-series aluminum materials is better.)

Specifically, two stop holes 73 are provided. The connection hole 74 is formed on the symmetric surface of the two stop holes 73. Each of the two stop holes 73 is configured with one support seat 3. This arrangement enables the mounting block 7 to cooperate with two support seats 3, increasing the use efficiency of the locking bolt 8.

More specifically, two connection holes 74 are provided. The two stop holes 73 are formed on the symmetric surface of the two connection holes 74. This arrangement makes the locking force of the mounting block 7 more balanced.

In this embodiment, a connection groove 75 is disposed on the reference surface 72 to connect the two connection grooves 75. The connection grooves 75 ensure the material used for the reference surface 72 at the stop holes 73 and the connection holes 74 during stamping.

In other embodiments, four stop holes 73 may be provided. The four stop holes 73 are disposed around the periphery of the two connection holes 74.

Specifically, the housing 1 is provided with a support seat receiving recess 11, a tap receiving recess 12 is disposed at the bottom of the support seat receiving recess 11, an annular boss 31 is disposed on the periphery of the support seat 3, the annular boss 31 is sandwiched between the bottom of the support seat receiving recess 11 and the cover plate 2, and the tap 6 is disposed in the tap receiving recess 12. This arrangement makes the support seat 3 easier to mount or remove than the cover plate 2 and the housing 1.

More specifically, the filter also includes a sealing ring 9 sleeved on the support seat 3 and sandwiched between the annular boss 31 and the cover plate 2. This arrangement prevents foreign matter from entering the housing 1 through the gap between the mounting hole and the support seat 3.

In this embodiment, the sum of the thicknesses of the ring boss 31 and the thicknesses of the sealing ring 9 along the axial direction of the support seat 3 is greater than the gap between the bottom of the support seat receiving recess 11 and the cover plate 2.

Specifically, the support seat 3 is provided with a through hole 32 along the axis of the support seat 3, a threaded portion is disposed at the end of the through hole 32 facing away from the housing 1, the connector 4 is threadedly connected to the threaded portion, a part of the metal rod 5 is located in the through hole 32, and the tap 6 is located outside the through hole 32. This arrangement enables the support seat 3 to support the connector 4 and the metal rod 5 more reliably.

More specifically, the connector 4 includes a head 41 and a threaded connection portion 42 that are coaxially connected to each other. The diameter of the head 41 is greater than the diameter of the threaded connection portion 42. The head 41 abuts against the side of the support seat 3 facing away from and the housing 1. The threaded connection portion 42 is threadedly connected to the threaded portion. This arrangement makes it more convenient to mount or remove the connector 4 on the support seat 3.

In this embodiment, the connector 4 also includes a rod 43 penetrating through the head 41 and the threaded connection portion 42, and the end of the rod 43 extending out of the threaded connection portion 42 is clamped in the metal rod 5. This arrangement ensures the effect of signal transmission.

Apparently, the preceding embodiments of the present application are merely illustrative examples of the present application and are not intended to limit implementations of the present application. Those of ordinary skill in the art can make changes or variations in other different forms based on the preceding description. All examples cannot be and do not need to be exhausted herein. Any modifications, equivalent substitutions and improvements made within the spirit and principle of the present application fall within the scope of the claims of the present application.

What is claimed is:

1. A filter, comprising:
a housing;
a cover plate disposed at an opening of the housing and provided with a mounting hole and a threaded hole;
at least one support seat penetrating through the mounting hole;
a connector disposed in a support seat of the at least one support seat, wherein one end of the connector extends out of an end of the support seat facing away from the housing;
a metal rod, wherein an end of the metal rod is connected to an other end of the connector;
a tap disposed in the housing and connected to another end of the metal rod;
a mounting block provided with a receiving recess on a side of the mounting block and a reference surface on an other side of the mounting block, wherein a stop hole and a connection hole are provided on the reference surface and are connected to a bottom of the receiving recess, the reference surface abuts against a side of the cover plate facing away from the housing, and the support seat penetrates through the stop hole; and
a locking bolt (8) penetrating through the connection hole and threadedly connected to the threaded hole.

2. The filter of claim 1, wherein two stop holes are provided on the reference surface, the connection hole is disposed on a symmetric surface of the two stop holes, and each of the two stop holes is configured with a respective one of the at least one support seat.

3. The filter of claim 2, wherein two connection holes are provided on the reference surface, and the two stop holes are disposed on a symmetric surface of the two connection holes.

4. The filter of claim 2, wherein a connection groove is disposed on the reference surface, and the connection groove connects the two stop holes.

5. The filter of claim 1, wherein the housing is provided with a support seat receiving recess (11), a tap receiving recess is disposed at a bottom of the support seat receiving recess (11), an annular boss is disposed on a periphery of the support seat, the annular boss is sandwiched between the bottom of the support seat receiving recess (11) and the cover plate, and the tap is disposed in the tap receiving recess.

6. The filter of claim 5, further comprising a sealing ring (9) sleeved on the support seat and sandwiched between the annular boss and the cover plate.

7. The filter of claim 1, wherein the support seat is provided with a through hole along an axis of the support seat, a threaded portion is disposed at an end of the through hole facing away from the housing, the connector is threadedly connected to the threaded portion, a part of the metal rod is located in the through hole, and the tap is located outside the through hole.

8. The filter of claim 7, wherein the connector comprises a head and a threaded connection portion, wherein the head and the threaded connection portion are coaxially connected to each other, a diameter of the head is greater than a diameter of the threaded connection portion, the head abuts against a side of the support seat facing away from the housing, and the threaded connection portion is threadedly connected to the threaded portion.

9. The filter of claim 8, wherein the connector further comprises a rod (43) penetrating through the head and the threaded connection portion, and an end of the rod (43) extending out of the threaded connection portion is clamped in the metal rod.

10. The filter of claim 1, wherein the mounting block is formed by stamping a sheet.
